(19) United States
(12) Patent Application Publication
(10) Pub. No.: US 2025/0199986 A1
(43) Pub. Date: Jun. 19, 2025

(54) COMMUNICATION HUB

(71) Applicant: Commissariat à l'Energie Atomique et aux Energies Alternatives, PARIS (FR)

(72) Inventors: Denis DUTOIT, GRENOBLE (FR); Anthony PHILIPPE, GRENOBLE (FR)

(21) Appl. No.: 18/970,764

(22) Filed: Dec. 5, 2024

(30) Foreign Application Priority Data
Dec. 15, 2023 (FR) 2314283

(51) Int. Cl. G06F 13/40; G06F 12/0817

(52) U.S. Cl. CPC G06F 13/409; G06F 12/0828; G06F 2212/621; G06F 2213/40

(57) ABSTRACT

The present description relates to a communication hub circuit comprising: two ports (P1) for exchanging data with another communication hub circuit (102); a port (P2) for exchanging data with a computing microchip (106); a port (P3) for exchanging data with an accelerator microchip (108); an interface (ITm) for exchanging data with a memory circuit (110); an interface (ITs, ITe) for exchanging data with a sensor (104); a data processing circuit (PUs); a network-on-chip (NOC) for transferring data between elements of the communication hub circuit.

### FIELD

The present description relates generally to electronic circuits.

### BACKGROUND

In the automotive field, a single manufacturer usually has a wide range of vehicles.

Further, the electronic/electrical architecture of vehicles is moving towards the centralization, in each vehicle, of calculations and data processing on a single platform, system or calculator, capable of addressing the multimedia and assisted or autonomous driving application requirements of the vehicle.

However, within a range of vehicles, each vehicle has different computing and data processing requirements depending, on the one hand, on the multimedia devices it comprises, i.e. the multimedia experience offered by this vehicle, and, on the other hand, on the level of its Advanced Driver Assistance System (ADAS), i.e., for example, the level L2, L2+, L3 or L4 of the driver assistance system from which the vehicle benefits.

To meet the computing and data processing requirements of a whole range of vehicles, a first solution is to install the same high-performance processor in each vehicle, and to program this processor by software according to the specific requirements of the vehicle. However, as such a processor should be able to meet the computing and data processing requirements of the highest-end vehicle, it will be oversized when installed in a lower-end vehicle, which is undesirable.

A second solution is to develop, in the form of a system-on-a-chip, a specific, dedicated and different calculator for each set of vehicles with similar computing and processing requirements. However, developing several different systems-on-a-chip is complex and undesirable, and further lacks scalability. This complexity leads to high development costs and technical difficulties.

### SUMMARY

There is a need to overcome some or all of the drawbacks of known calculators addressing different calculation and data processing requirements between products in the same product range, for example between vehicles in the same vehicle range.

One embodiment overcomes some or all of the drawbacks of known calculators addressing different calculation and data processing requirements between products in the same product range, for example between vehicles in the same vehicle range.

One embodiment provides a communication hub circuit comprising:
at least two first physical ports each configured to exchange data with another communication hub circuit forming part of the same cache-coherent memory area as said hub circuit, when said first port is connected via a high-speed link to this other communication hub circuit;
at least one second physical port configured to exchange data with a computing microchip forming part of said same cache-coherent memory area when said at least one second physical port is connected via a high-speed link to this computing microchip;
at least one third physical port configured to exchange data with an accelerator microchip forming part of an input/output coherent memory area with said same cache coherent memory area, when said at least one third physical port is connected via a high-speed link to this accelerator microchip;
at least one first interface configured to exchange data with a memory circuit forming part of said same cache-coherent memory area when said at least one first interface is connected to this memory circuit;
at least one second interface configured to exchange data with a sensor;
at least one processing circuit configured to implement data processing;
at least one network-on-chip configured to transfer data between elements of the communication hub circuit, said elements comprising said at least two first ports, said at least one second port, said
at least one third port, said at least one processing circuit and said at least one first interface.

According to one embodiment:
said at least two first physical ports are each configured to implement a CXL.mem and CXL.cache or AXI stream protocol when exchanging data with the other communication hub circuit;
said at least one second physical port is configured to implement a CXL.cache and CXL.mem protocol when exchanging data with the computing microchip; and
said at least one third physical port is configured to implement a CXL.mem, CXL.io, or PCIe protocol when exchanging data with the accelerator microchip.

According to one embodiment, the hub circuit is configured to merge several data flows it receives without implementing any processing on said several flows.

According to one embodiment, the hub circuit is configured to perform processing on the separate data flows it receives, and then to merge the results of these processing.

According to one embodiment, the hub circuit is configured to implement cache coherency in said same cache-coherent memory area.

According to one embodiment, the hub circuit is configured to implement I/O coherency between the same cache-coherent memory area and another memory area to which an accelerator microchip belongs.

According to one embodiment, said at least one first interface comprises an interface for a DDR-type memory and/or an interface for a FLASH-type memory.

According to one embodiment, the hub circuit further comprises a direct memory access circuit.

According to one embodiment, said at least one second interface comprises at least one CSI-type interface and/or at least one Ethernet-type interface.

According to one embodiment, the hub circuit further comprises at least one third interface configured to exchange data with a display.

Another embodiment provides a system comprising:
exactly one hub circuit as described above; and
a memory connected to said at least one first interface, no computing microchip and accelerator microchip being connected to the hub circuit.

Another embodiment provides a system comprising:
exactly one hub circuit as described above; and
a computing microchip connected to said at least one second port of the hub circuit by a high-speed link, no other computing microchip and no accelerator microchip being connected to the hub circuit.

Another embodiment provides a system comprising:
exactly one first hub circuit as described above and one second hub circuit as described above, one of the first ports of the first hub circuit being connected to one of the first ports of the second hub circuit by a first high-speed link;
a first computing microchip connected to said at least one second port of the first hub circuit by a second high-speed link, no other computing microchip and no accelerator microchip being connected to the first hub circuit; and
a second computing microchip connected to said at least one second port of the second hub circuit by a third high-speed link, no other computing microchip and no accelerator microchip being connected to the second hub circuit.

Another embodiment provides a system comprising:
exactly one first hub circuit as described above and one second hub circuit as described above, one of the first ports of the first hub circuit being connected to one of the first ports of the second hub circuit by a first high-speed link;
a first computing microchip connected to said at least one second port of the first hub circuit by a second high-speed link, no other computing microchip and no accelerator microchip being connected to the first hub circuit; and
a first accelerator microchip connected to said at least one third port of the second hub circuit by a third high-speed link, no other accelerator microchip and no computing microchip being connected to the second hub circuit.

Another embodiment provides a system comprising:
exactly one first hub circuit as described above, one second hub circuit as described above, one third hub circuit as described above, one fourth hub circuit as described above, one of the first ports of the first circuit being connected to one of the first ports of the second circuit by a first high-speed link, another of the first ports of the second circuit being connected to one of the first ports of the third circuit by a second high-speed link, another of the first ports of the third circuit being connected to one of the first ports of the fourth circuit by a third high-speed link, another of the first ports of the fourth circuit being connected to another of the first ports of the first circuit by a fourth high-speed link;
a first computing microchip connected to said at least one second port of the first hub circuit by a fifth high-speed link, no other computing microchip and no accelerator microchip being connected to the first hub circuit;
a second computing microchip connected to said at least one second port of the second hub circuit by a sixth high-speed link, no other computing microchip and no accelerator microchip being connected to the second hub circuit;
a first accelerator microchip connected to said at least one third port of the third hub circuit by a seventh high-speed link, no other accelerator microchip and no computing microchip being connected to the third hub circuit;
a second accelerator microchip connected to said at least one third port of the fourth hub circuit by an eighth high-speed link, no other accelerator microchip and no computing microchip being connected to the fourth hub circuit.

According to one embodiment, each accelerator microchip is configured to implement data processing for advanced pilot assistance systems with a level L2+, L3 or L4.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates, schematically and in block form, an example embodiment of a computing and data processing system;

FIG. 2 illustrates, in greater detail, an example embodiment of a basic component of the system shown in FIG. 1;

FIG. 3 illustrates, in greater detail, an example embodiment of another component of the system shown in FIG. 1;

FIG. 4 illustrates, in greater detail, an example embodiment of yet another component of the system shown in FIG. 1;

FIG. 5 illustrates, schematically and in block form, an example embodiment of a first computing and data processing system;

FIG. 6 illustrates, schematically and in block form, an example embodiment of a second computing and data processing system;

FIG. 7 illustrates, schematically and in block form, an example embodiment of a third computing and data processing system;

FIG. 8 illustrates, schematically and in block form, an example embodiment of a fourth computing and data processing system;

FIG. 9 illustrates, schematically and in block form, an example embodiment of a fifth computing and data processing system; and

FIG. 10 illustrates how the first, second, third, fourth and fifth systems match the calculation and data processing requirements of a range of motor vehicles.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

To address the different computing and data processing requirements between vehicles in the same vehicle range, a solution is proposed here based on the hardware disaggregation of a range of computing and data processing systems. Hardware disaggregation consists in cutting up the hardware architecture of a circuit into several distinct functional elements manufactured separately in the form of integrated circuits referred to as “chiplets”, then re-arranging and assembling these chiplets in a single package to form a component. U.S. Pat. No. 11,756,150 presents the principle of hardware disaggregation into microchips.

However, in the above-mentioned patent, the disaggregation is based on computational functionalities, and therefore does not allow addressing the requirements of products, for example motor vehicles, linked to the management of the many data flows, for example from numerous sensors, which serve as input data for the computational algorithms performed by the microchips.

U.S. Pat. No. 11,100,028 presents a programmable component for data routing and data flow protocol transposition between microchips. However, this solution requires the programmable component to be associated with at least one microchip, which may not be desirable for addressing the computing and data processing requirements of the lowest-end products in a product range, for example the lowest-end vehicles in a vehicle range. Further, even when this component is associated with one or more microchips, the limitation of this component to data routing and data flow protocol transposition may not be sufficient to address the specific requirements of products in a product range, for example vehicles in a vehicle range.

For the design of calculators based on microchip disaggregation, a component, hereinafter referred to as a communication hub, is proposed to overcome the drawbacks described above.

FIG. 1 illustrates, schematically and in block form, an example embodiment of a system 100 for calculating and data processing, based on disaggregation into microchips and at least one data hub.

System 100 comprises at least one communication hub 102 (block COM HUB in FIG. 1). In this example, the system 100 comprises two hubs 102.

Each hub 102 is configured to be connected, in a modular fashion, to several other integrated circuits in the system 100. Each hub 102 is further configured to exchange data flows, or, put it more simply, data, with other integrated circuits, or elements, in the system 100.

The hub(s) 102 of the system 100 are configured to route data flows through the system 100.

For example, each hub 102 is configured to acquire data or data flows from one or more sensors 104 (block “SENSOR” in FIG. 1) of the system 100. In the example shown in FIG. 1, the system 100 comprises a single sensor 104, although in practice a system 100 may comprise more.

For example, each hub 102 is configured to redirect received data or data flows to a microchip of the system 100 for processing by the microchip. For example, a hub receiving data from a sensor can send it back, after simple encapsulation and without calculation on this data, to another microchip or another hub of the system 100 so that this data can be processed, i.e. so that calculations and processing can be carried out on this data.

The system 100 can comprise two types of microchip, namely, computing microchips 106 (block “CHIPLET C” in FIG. 1), and accelerator microchips 108 (block “CHIPLET A” in FIG. 1). Microchips 106 are generic computing and processing circuits. As such, each microchip 106 can address a wide variety of processing and calculation tasks, relatively simple compared to those addressed by the microchips 108. For example, each microchip 106 is software-programmable. For example, each microchip 106 is a generic processor. Conversely, the microchips 108 are integrated circuits specifically designed to address specific calculation and processing requirements, relatively complex compared to those addressed by the microchips 106. In other words, unlike microchips 106, which implement generic calculation and processing functions, microchips 108 implement specific calculation and processing functions to accelerate the implementation of some specific system functionalities. microchips 108 are then, for example, referred to as accelerator microchips 108.

By way of example, when the system 100 implements a computer for a motor vehicle, the microchips 108 of the system 100 can implement accelerator functions specific to the requirements of autonomous driving, for example ADAS levels L3 and L4.

In the example shown in FIG. 1, the system 100 comprises exactly two microchips 108 and exactly one microchip 106, although in other examples the system 100 may:
comprise any non-zero number of microchips 106 and no microchips 108,
comprise any non-zero number of microchips 108 and no microchips 106,
comprise any non-zero number of microchips 108 and any non-zero number of microchips 106, or
comprise no microchips 106 and 108.

Still by way of example, each hub 102 is further configured to ensure the collection of data or data flows in memory, for example for subsequent use of this data by the system 100. By way of example, each hub 102 is configured to control the recording of data or data flows, for example:
in a memory circuit or memory 110 (block “MEM” in FIG. 1) associated with, i.e. connected to, this hub 102,
in a memory 110 associated with another hub 102 to which this hub 102 is connected or coupled,
in a memory 110 associated with, i.e. connected to, a microchip 106 or 108, whether this microchip 106 or 108 is associated with, i.e. connected to, this hub 102 or simply coupled to this hub 102 via another hub 102.

For example, each hub 102 is associated with at least one memory 110. For example, each microchip 106 is associated with at least one memory 110, preferably exactly one memory 110. For example, each microchip 108 is associated with at least one memory 110, preferably exactly one memory 110.

By way of example, each memory 110 associated with (i.e. connected to) a microchip 108 or 106 is of the Dual Data Rate (DDR) type, although each memory associated with a microchip 106 or 108 may also be of another type, for example a FLASH memory.

By way of example, each memory 110 associated with (i.e. connected to) a circuit 102 is of the Dual Data Rate (DDR) or FLASH type, although other types of memory can be contemplated.

Thus, in the system 100, there is a functional partitioning with, on the one hand, the management of communications by the hub(s) 102 of the system 100, and, on the other hand, the management of calculations and processing by the microchips 106 and 108.

This partitioning, in which the microchips 106 and 108 are not responsible for redistributing communications, or data, within the system 100, favours the grouping of analog functions in the communications hub(s) 102 of the system 100. For example, the physical layers of the communications interfaces are grouped together in the circuit(s) 102 of the system 100, so that the microchips 106 and 108 can be devoid of these physical layers in their communications interfaces.

To perform the function of redistributing data flows within the system 100, each hub 102 comprises a Network on Chip (NoC) configured to redistribute, within the circuit 102, data between the various components forming the circuit 102, for example, in particular between the input/output ports and the interfaces of the hub.

In addition to managing the redistribution of communications or data transmissions within the system 100, between the various circuits forming it, each hub 102 is preferably configured to implement protocol transpositions between data it receives and corresponding data it retransmits to another element of the system.

Furthermore, in addition to managing the redistribution of data flows within the system 100, with or without protocol transposition, each hub 102 is preferably configured to perform mergers of separate data flows received, without pre-processing the received data flows, and then to provide the resulting merged data flow to another element of the system 100. In other words, each hub 102 is configured to implement “early fusion” of separate data flows it receives. Preferably, each hub 102 is further configured to perform processing, beyond simple protocol transposition, on separate data flows it receives, and then to merge the results of this pre-processing to provide a corresponding merged data flow. In other words, each hub 102 is configured to implement “late fusion” of the separate data flows it receives. The fact that each hub 102 is configured to implement both late and early fusions allows multimodal fusions of separate data flows the to be implemented, multimodal fusion strategies being, for example, particularly advantageous to implement for the field of artificial intelligence.

By way of example, to implement the fusions described above, each circuit 102 comprises at least one data processing circuit configured to implement calculations and processing on the data going beyond simple protocol transposition.

According to one embodiment, each hub 102 is configured to implement processing or calculations on data, for example relatively simple processing or calculations compared with those implemented by the accelerator microchips 108. In this way, a system 100 comprising only a single hub 102, and devoid of microchips 106 and 108, allows relatively low computing and processing requirements, for example the computing and processing requirements of the lowest-end vehicles in a vehicle range, to be met. In other words, a system 100 comprising only one hub 102 and devoid of microchips 106 and 108 has a relatively low operating intensity, i.e. the maximum number of operations per second that the system can process is relatively low compared with a system comprising microchips 106, 108 and/or other hubs. By way of example, the hub 102 has an operating intensity at least twice as low as that of each microchip 106, 108 which may be connected to this hub.

For example, to implement the data processing described above, each hub 102 comprises at least one processing circuit selected from the group comprising Central Processing Units (CPUs), Graphic Processing Units (GPUs), Digital Signal Processors (DSPs), and Neural Processing Units (NPUs).

In order to be connected to one or more memory circuits 110, each hub 102 comprises at least one memory interface ITm configured to exchange data with a memory circuit 110 when such a memory 110 is connected to this interface ITm.

By way of example, each interface ITm can be configured for connection to a DDR-type memory. In this case, the interface is said to be of the DDR-type. For example, a DDR-type interface ITm is implemented by a memory controller for a DDR-type memory. By way of alternative example, each interface ITm can be configured for connection to a FLASH memory. In this case, the interface ITm is said to be of the FLASH-type. For example, a FLASH-type interface ITm is implemented by a Low-Voltage Differential Signaling (LVDS) interface adapted to communicate with a FLASH-type memory circuit 110. By way of example, when the hub 102 comprises several interfaces ITm, these interfaces ITm can be of different types, for example a first interface ITm is of the DDR-type, while a second interface ITm is of the FLASH-type.

Each interface ITm of each hub 102 can be either connected to a memory circuit 110, or not connected at all. However, it is preferable that at least one interface ITm of each hub 102 is connected to a memory 110.

Similarly, in order to be connected to a memory circuit 110, each microchip 106 comprises a memory interface ITmc configured to be connected to this memory 110. In the same way as the interfaces ITm, each interface ITmc can be of a given type, for example DDR or FLASH, for example different from that of another interface ITmc.

Each interface ITmc on each microchip 106 can either be connected to a memory circuit 110, or not connected at all.

Further, in order to be connected to a memory circuit 110, each microchip 108 comprises a memory interface ITma configured to be connected to this memory 110. In the same way as the interfaces ITm and ITmc, each interface ITma can be of a given type, for example DDR or FLASH, for example different from that of another interface ITma.

Each interface ITma on each microchip 108 can either be connected to a memory circuit 110, or not connected at all.

Further, each memory circuit 110 is preferably connected to only one of a hub 102, a microchip 106, and a microchip 108, the memory 110 then being said to be associated with this element.

Although this is not the case in the example shown in FIG. 1, a microchip 108 may not be connected to any memory 110, and/or a microchip 106 may not be connected to any memory 110, and/or a hub may not be connected to any memory 110. However, a hub 102 will preferably be associated with a memory 110, for example a memory comprising code executable by the hub 102, for example so as to program the hub 102.

The memories 110 of system 100 implement the shared or distributed memory of system 100.

Furthermore, each hub 102 comprises at least two physical ports P1. Each port P1 is configured to exchange data with another hub 102 when the hub 102 comprising this port P1 is connected. In other words, each port P1 is configured to exchange data with another hub 102 to which this port P1 is connected. The connection of two hubs 102 via two respective ports P1 of these two hubs 102 is implemented by a High-Speed Link (HSL). By way of example, a high-speed link is configured to transfer at least 4 gigabytes per second, preferably at least 8 gigabytes per second, regardless of whether this HSL link is a serial or parallel link. In FIG. 1, the high-speed links between two circuits 102 are referenced 112, the system 100 in the example shown in FIG. 1 comprising just one link 112.

Each hub 102, and more particularly each port P1 of this hub 102, is configured, when connected to the port P1 of another hub 102 by a link 112, for example another hub 102 forming part of the same system as this hub 102, so that the two hubs 102 and the memory(ies) 110 to which these hubs are connected, form part of the same cache-coherent memory area 116 (delimited by dotted lines in FIG. 1). This cache-coherent memory area 116 is attached to, or associated with, these two hubs 102. Preferably, all hubs 102 in a system 100 are part of the same cache-coherent memory area. The cache-coherent memory area 116 is, for example, a memory distributed between several memories 110 forming part of the memory area 116.

In this way, each port P1 of each hub 102 can be connected either to the port P1 of another hub 102 via a link 112, or to nothing at all.

Each hub 102 further comprises at least one interface, for example an interface ITs, configured to exchange data with a sensor 104 when connected to this sensor 104. The connection of interface ITs to a sensor is, for example, implemented via a link 118 which is not a high-speed link. By way of example, each hub 102 can comprise at least one interface ITs of the Camera Serial Interface (CSI) type. Of course, each interface ITs of each hub 102 may be of a type other than CSI.

Each hub 102 comprises at least one physical port P2. Each port P2 is configured to exchange data with a computing microchip 106 when this port P2 is connected to this microchip 106. The connection of a microchip 106 to the port P2 of a hub 102 is implemented by a high-speed link (HSL). In FIG. 1, the high-speed links between two circuits 102 and 106 are referenced 120, as the system 100 in the example shown in FIG. 1 comprises just one link 120. By way of example, each microchip 106 comprises a physical port P2c similar to the port P2 of the hub 102 to which this microchip 106 is connected by a corresponding link 120 coupling these ports P2 and P2c to each other.

Each hub 102, and more particularly each port P2 of hub 102, is configured, when connected to a microchip 106 by a link 120, so that the microchip 106 and any memory 110 to which the microchip 106 is connected form part of the same cache-coherent memory area 116 as the hub 102 to which the microchip 106 is connected. By way of example, this cache coherency within the shared memory area 116 is implemented by each of the hubs 102 to which this area 116 is attached.

Each port P2 on each hub 102 can either be connected to a computing microchip 106 via a link 120, or be connected to nothing at all.

Each hub 102 comprises at least one physical port P3. Each port P3 is configured to exchange data with an accelerator microchip 108 when this port P3 is connected to this microchip 108. The connection of a microchip 108 to the port P3 of a hub 102 is implemented by a high-speed link (HSL). In FIG. 1, the high-speed links between two circuits 102 and 108 are referenced 122, as the system 100 in the example shown in FIG. 1 comprises just two links 122. By way of example, each microchip 108 comprises a physical port P3a similar to the port P3 of the hub 102 to which this microchip 108 is connected by a corresponding link 122 coupling these ports P3 and P3a to each other.

Each hub 102, and more particularly each port P3 of the hub 102, is configured, when connected to a microchip 108 by a link 122, so that the microchip 108 and any memory 110 to which the microchip 108 is connected form part of a memory area 124 with input/output coherency relative to the cache-coherent memory area 116 to which the hub 102 connected to this microchip 108 belongs. In FIG. 1, in the example system 100 shown, two microchips 108 are connected to two respective hubs 102, the two hubs 102 forming part of the cache-coherent area 116, and the two microchips 108 each forming part of a respective memory area 124 (delimited by dotted lines in FIG. 1) with input/output coherency with respect to the memory area 116.

By way of example, this input/output coherency between a memory area 124 to which a microchip 108 belongs and the cache-coherent memory area 116 to which the hub 102 connected to this microchip 108 belongs is implemented by the hub(s) 102 of the system 100.

Each port P3 on each hub 102 can either be connected to an accelerator microchip 108 via a link 122, or be connected to nothing at all.

Although not illustrated in the example system 100 shown in FIG. 1, in addition to the physical ports P1, P2 and P3 and the interfaces ITm and ITs, each hub may also comprise:
at least one Ethernet-type interface ITe, for example intended to a connection to a modem, i.e. a modulator/demodulator circuit, or for example intended to a connection to a LIght and Detection And Ranging (LIDAR) sensor. An interface ITe can therefore be used, in the same way as interfaces ITs, to connect a sensor 104 to a hub 102; and/or
at least one interface ITd intended to be connected to a display, for example a Low-Voltage Differential Signaling (LVDS) interface.

Further, although not illustrated in the example system 100 of FIG. 1, in addition to the physical ports, interfaces, of its processing circuit(s) and network-on-a-chip, each circuit 102 may comprise a Direct Memory Access (DMA) circuit. This circuit is, for example, configured to handle data transfers, for example mainly data from a sensor 104 connected to an interface ITs or ITe of the hub 102.

Preferably, when a system 100 comprises several hubs 102 connected in a network, these hubs are identical to each other.

By way of example, ports P3 and P3a are each configured to implement a “CXL.mem”, “CXL.io” or “PCIe” protocol when a port P3 is connected to a port P3c via a link 122, i.e. during a data exchange between a hub 102 and an accelerator microchip 108.

By way of example, ports P2 and P2c are each configured to implement a “CXL.cache” and “CXL.mem” protocol when a port P2 is connected to a port P2c via a link 120, i.e. during a data exchange between a hub 102 and a computing microchip 106.

By way of example, each port P1 is configured to implement a “CXL.mem” and “CXL.cache” or “AXI stream” protocol when connected, via a link 112, to the port P1 of another hub 102, i.e. when exchanging data with this other hub.

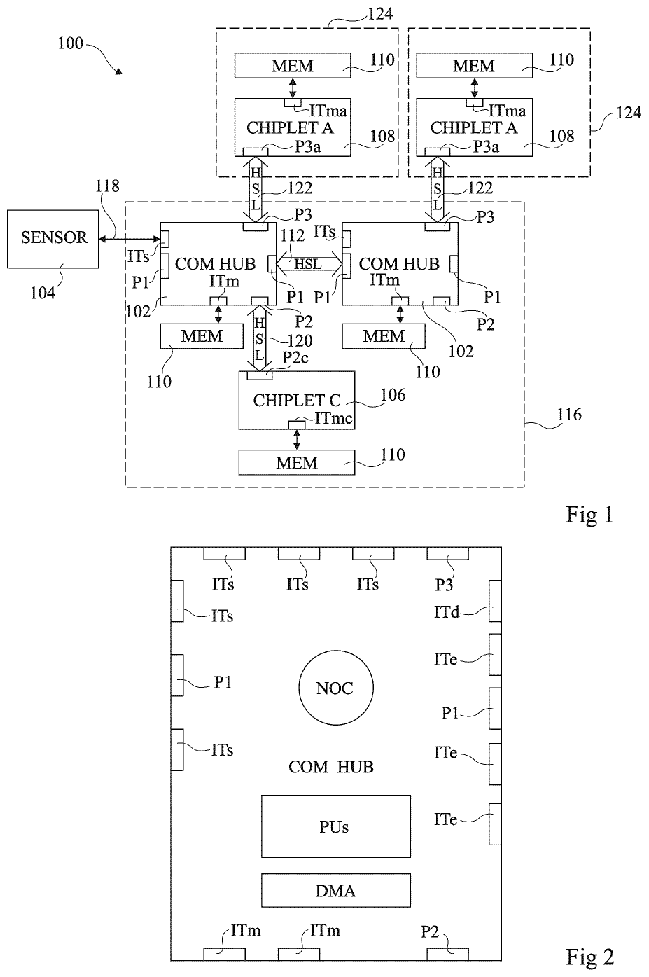

FIG. 2 illustrates, in greater detail, an example embodiment of a circuit 102 of the system shown in FIG. 1.

Circuit 102 (block “COM HUB” in FIG. 2) comprises, as indicated above in relation to FIG. 1:
at least two ports P1, e.g. exactly two ports P1 in the example shown in FIG. 2;
at least one port P2, e.g. exactly one port P2 in the example shown in FIG. 2;
at least one port P3, e.g. exactly one port P3 in the example shown in FIG. 2;
at least one interface ITs, for example exactly five interfaces ITs in the example shown in FIG. 2, e.g. all of CSI-type;
at least one interface ITm, for example exactly two interfaces ITm in the example shown in FIG. 2, e.g. one FLASH-type interface ITm and one DDR-type interface ITm;
at least one processing unit, shown as a block PUs in FIG. 2; and
a network-on-chip NOC.

In the example shown in FIG. 2, circuit 102 further comprises a direct memory access circuit (block “DMA” in FIG. 2).

Still in the example shown in FIG. 2, circuit 102 comprises at least one Ethernet-type interface ITe, for example exactly three interfaces ITe in the example shown in FIG. 2.

Still in this example, circuit 102 comprises at least one interface ITd, for example exactly one interface ITd in the example shown in FIG. 2, for example of the Low-Voltage Differential Signaling (LVDS) type.

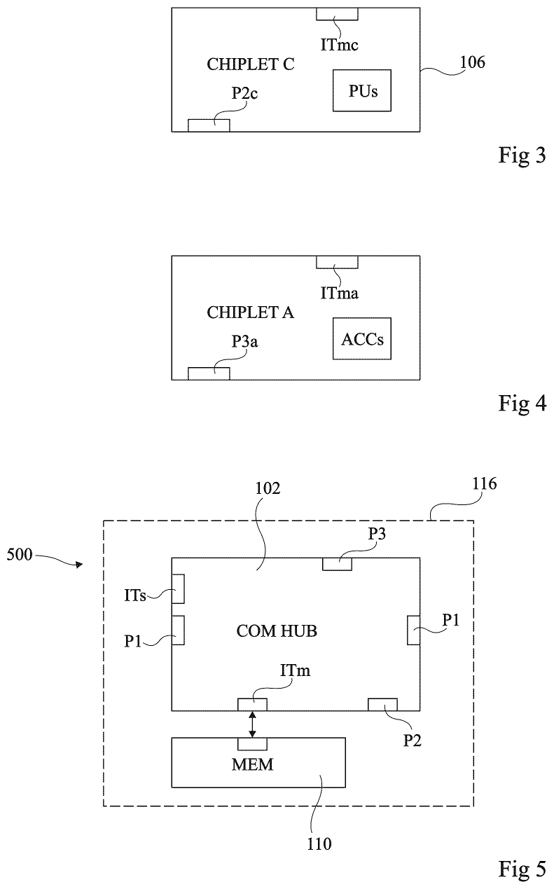

FIG. 3 illustrates, in greater detail, an example embodiment of a computing microchip 106 of the system 100 shown in FIG. 1.

The microchip 106 (block “CHIPLET C” in FIG. 3) comprises at least one memory interface ITmc, preferably a single memory interface ITmc. For example, this interface ITmc is of the DDR-type, and is then configured to be connected to a DDR-type memory 110.

The microchip 106 further comprises a physical port P2c for connection, via a link 120, to the port P2 of a hub 102.

Finally, the microchip 106 comprises one or more processing units, represented by a single block PUs in FIG. 3. By way of example, the processing unit(s) of a microchip 106 are selected from the group comprising CPUs, GPUs and NPUs. By way of example, as the microchip 106 is designed to implement generic functionalities compared with the specific functionalities of the microchips 108, the microchip 106 does not comprise a DSP.

Preferably, all the microchips 106 in a system 100 have a similar or identical architecture to that of the microchip 106 described in relation to FIG. 3.

FIG. 4 illustrates, in greater detail, an example embodiment of an accelerator microchip 108 of the system 100 shown in FIG. 1.

Microchip 108 (block “CHIPLET A” in FIG. 4) comprises at least one memory interface ITma, preferably a single memory interface ITma. For example, this interface ITma is of the DDR-type, and is then configured to be connected to a DDR-type memory 110.

The microchip 108 further comprises a physical port P3a for connection, via a link 122, to the port P3 of a hub 102.

Finally, the microchip 108 comprises one or more processing units, represented by a single block ACCs in FIG. 4. By way of example, the processing unit(s) of a microchip 108 are selected from the group comprising CPUs, GPUs, DSPs and NPUs. By way of example, as the microchip 108 is designed to implement specific functionalities compared with the generic functionalities of microchips 106, the microchip 108 comprises a DSP and/or a GPU.

Preferably, all the microchips 108 in a system 100 have a similar or identical architecture to that of the microchip 108 described in relation to FIG. 4.

According to one embodiment, the processing unit(s) PUs of a microchip 108 are configured to implement assisted or autonomous driving functionalities.

Various examples of systems based on at least one hub 102 and, when required by the application, at least one microchip 106 and/or at least one microchip 108, will now be described.

Of course, these examples of systems are not limitative, and those skilled in the art will be able to foresee many other examples of systems or computers obtained by assembling, i.e. by reaggregating, one or more hubs 102 with one or more microchips 106 and/or 108.

FIG. 5 illustrates schematically and in block form an example embodiment of a computing and data processing system 500.

Compared with system 100, system 500 comprises just one circuit 102, and is devoid of microchip 106 and microchip 108.

In other words, system 500 comprises exactly one circuit 102, and no microchips 106 or 108 are connected to this circuit 102.

A memory circuit 110 is connected to the interface ITm of circuit 102.

The circuit 102, and its associated memory 110, belong to a cache-coherent memory area 116.

Since circuit 102 comprises at least one processing unit, system 500 can address processing and calculation requirements while no microchips 106, 108 are connected to circuit 102.

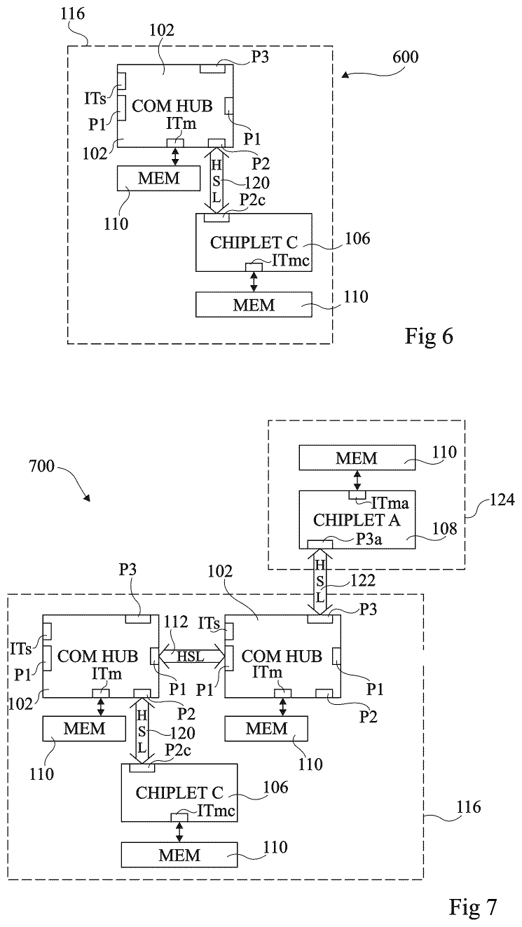

FIG. 6 illustrates, schematically and in block form, an example embodiment of a computing and data processing system 600.

Like system 500, system 600 comprises exactly one circuit 102 and a memory circuit 110 associated with this circuit 102.

However, in comparison with system 500, a microchip 106 is connected, via a link 120, to the port P2 of circuit 102. For example, link 120 connects port P2 of circuit 102 to port P2c of microchip 106.

In this example, a memory circuit 110 is connected to the interface ITmc of microchip 106, this memory being associated with microchip 106.

The hub 102 and its associated memory 110 as well as the microchip 106 and its associated memory 110 are part of the same cache-coherent memory area 116.

FIG. 7 illustrates, schematically and in block form, an example embodiment of a computing and data processing system 700.

Compared with systems 500 and 600, system 700 comprises exactly two hub circuits 102, exactly one microchip 106 and exactly one microchip 108.

The two circuits 102 are connected to each other. For example, a port P1 of one of the circuits 102 is connected to a port P1 of the other circuit 102, via a link 112.

By way of example, each circuit 102 is associated with a corresponding memory circuit 110. For example, each circuit 102 has an interface ITm connected to the memory circuit 110 with which it is associated.

A microchip 106 is connected, via a link 120, to the port P2 of a first of the two circuits 102, the one on the left in FIG. 7. For example, link 120 connects port P2 of the first circuit 102 to port P2c of microchip 106.

In this example, a memory circuit 110 is connected to the interface ITmc of microchip 106, this memory being associated with microchip 106.

Further, a microchip 108 is connected, via a link 122, to port P3 of the second of the two circuits 102, the one on the right in FIG. 7. For example, link 122 connects port P3 of the second circuit 102 to port P3a of microchip 108.

In this example, a memory circuit 110 is connected to the interface ITma of microchip 108, this memory being associated with microchip 108.

The two hubs 102 and their associated memories 110 as well as the microchip 106 and its associated memory 110 form part of a single cache-coherent memory area 116.

In contrast, microchip 108 and its associated memory 110 form part of another memory area 124, this other memory area 124 being input/output coherent with respect to memory area 116.

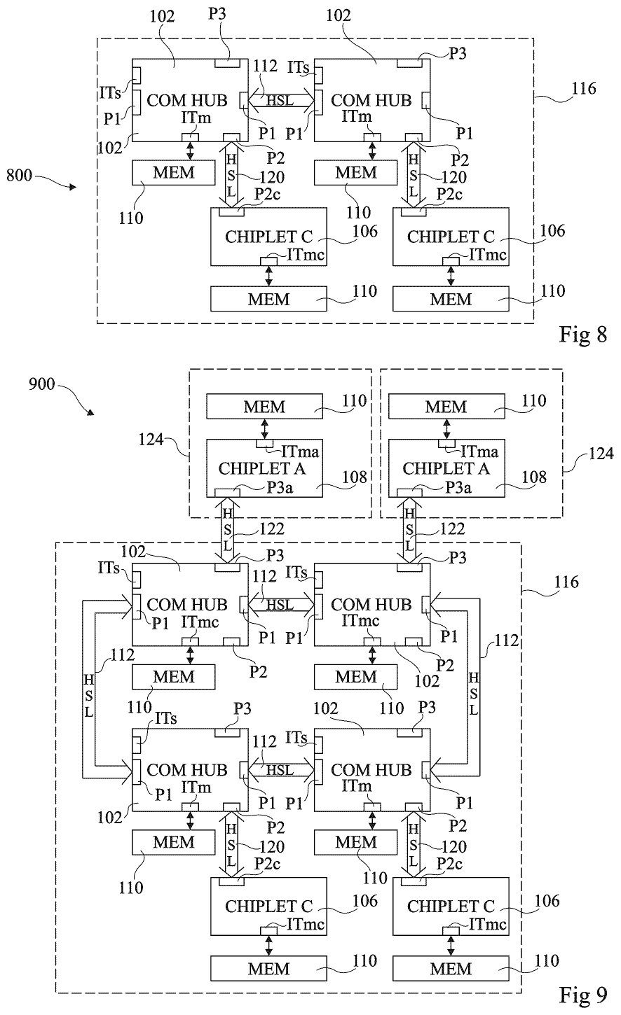

FIG. 8 illustrates, schematically and in block form, an example embodiment of a computing and data processing system 800.

Like system 700, system 800 comprises exactly two hub circuits 102. However, unlike system 700, system 800 comprises exactly two microchips 106 and no microchip 108.

The two circuits 102 are connected to each other. For example, a port P1 of one of the circuits 102 is connected to a port P1 of the other circuit 102, via a link 112.

By way of example, each circuit 102 is associated with a corresponding memory circuit 110. For example, each circuit 102 has an interface ITm connected to the memory circuit 110 with which it is associated.

A first microchip 106 is connected, via a link 120, to the port P2 of a first of the two circuits 102. For example, the link 120 connects the port P2 of the first circuit 102 to the port P2c of the first microchip 106.

In this example, a memory circuit 110 is connected to the interface ITmc of the first microchip 106, this memory being associated with the microchip 106.

Further, a second microchip 106 is connected, via a link 120, to the port P2 of the second of the two circuits 102. For example, the link 120 connects the port P2 of the second circuit 102 to the port P2c of the second microchip 106.

In this example, a memory circuit 110 is connected to the interface ITmc of the second microchip 106, this memory being associated with the microchip 106.

The two hubs 102 and their associated memories 110 as well as the two microchips 106 and their associated memories 110 form part of a single cache-coherent memory area 116.

FIG. 9 illustrates, schematically and in block form, an example embodiment of a computing and data processing system 900.

System 900 comprises exactly four circuits 102, namely a first hub 102 (top left in FIG. 9), a second hub 102 (top right in FIG. 9), a third hub 102 (bottom right in FIG. 9) and a fourth hub 102 (bottom left in FIG. 9).

In this example, each of the hubs 102 is associated with a corresponding memory circuit 110, the memory circuit 110 associated with a hub 102 being connected to an interface ITm of this hub 102.

The circuits 102 are coupled to each other. For example, the circuits 102 form a two-dimensional network. For example, a port P1 of the first circuit 102 is connected to a port P1 of the second circuit 102 by a first link 112, another port P1 of the second circuit 102 is connected to a port P1 of the third circuit 102 by a second link 112, another port P1 of the third circuit 102 is connected to a port P1 of the fourth circuit by a third link 112, and another port P1 of the fourth circuit is connected to another port P1 of the first circuit 102 by a fourth link 112.

Furthermore, the system 900 comprises exactly two microchips 106. A first microchip 106 is connected, via a link 120, to the port P2 of the third circuit 102. For example, the link 120 connects the port P2 of the third circuit 102 to the port P2c of the first microchip 106. In this example, a memory circuit 110 is connected to the interface ITmc of the first microchip 106, this memory being associated with the microchip 106. The second microchip 106 is connected, via a further link 120, to the port P2 of the fourth circuit 102. For example, this further link 120 connects the port P2 of the fourth circuit 102 to the port P2c of the second microchip 106. In this example, a memory circuit 110 is connected to the interface ITmc of the second microchip 106, this memory being associated with the microchip 106.

Further, the system 900 comprises exactly two microchips 108. A first microchip 108 is connected, via a link 122, to the port P3 of the first circuit 102. For example, the link 122 connects the port P3 of the first circuit 102 to the port P3a of the first microchip 108. In this example, a memory circuit 110 is connected to the interface ITma of the first microchip 108, this memory being associated with the microchip 108. The second microchip 108 is connected, via a further link 122, to the port P3 of the second circuit 102. For example, this further link 122 connects the port P3 of the second circuit 102 to the port P3a of the second microchip 108. In this example, a memory circuit 110 is connected to the interface ITma of the second microchip 108, this memory being associated with the microchip 108.

The two hubs 102 and their associated memories 110 as well as the two microchips 106 and their associated memories 110 form part of a same cache-coherent memory area 116.

In contrast, the two microchips 108 and their associated memories 110 each form part of another memory area 124, this other memory area 124 being input/output coherent with respect to memory area 116.

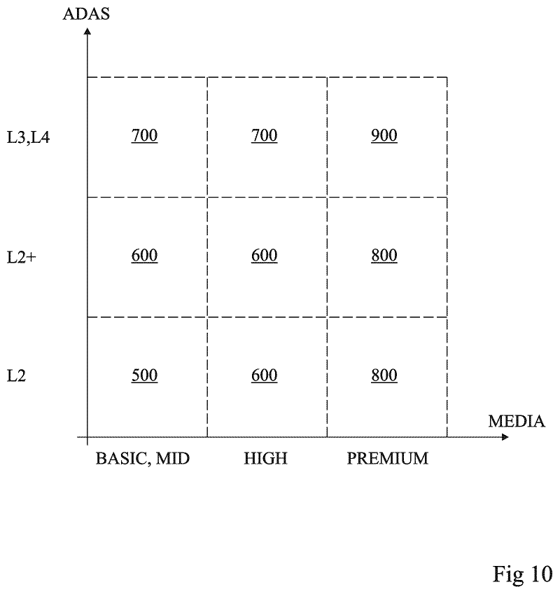

FIG. 10 illustrates, in the form of a table, the suitability of the systems shown in FIGS. 5 to 9 for the calculation and data processing requirements of a range of motor vehicles.

In particular, the x-axis of the table, referred to as MEDIA in FIG. 10, represents the computational and data processing requirements as a function of the multimedia experience offered by a vehicle, these requirements being lowest when the vehicle offers a low multimedia experience (“BASIC, MID” in FIG. 10), highest when the vehicle offers a medium multimedia experience (“HIGH” in FIG. 10), and highest when the vehicle offers a high multimedia experience (“PREMIUM” in FIG. 10).

Further, the y-axis of the table, referred to as ADAS in FIG. 10, represents the level of the pilot assistance system, ADAS, with only levels L2, L2+, L3 and L4 shown in FIG. 10, with levels L3 and L4 grouped together into a single group L3, L4.

For a motor vehicle offering a multimedia experience BASIC, MID with ADAS level L2, i.e. a low-end vehicle, a single circuit 102 can satisfy the computing and data processing requirements of the vehicle, and a system 500 can be used as the calculator for this vehicle.

For a motor vehicle with the same infotainment level BASIC, MID, but an ADAS level L2+, computing and data processing requirements increase due to the increase in ADAS level, and a microchip 106 is then added to meet this increase. System 600 is therefore able to address the application requirements of this vehicle. The microchip 106 of the system 600 is then, for example, configured to handle calculations related to ADAS level L2+.

Further, the microchip 106 of the system 600 is sufficiently generic to allow the computing and data processing requirements of a vehicle with an infotainment level HIGH and an ADAS level L2 or even L2+to be addressed.

In contrast, for a vehicle with an infotainment level BASIC, MID or HIGH, and an ADAS level L3 or L4, the calculation and processing requirements specific to ADAS levels L3 and L4 require the addition of a microchip 108 and a hub 102. In this way, system 700 allows the computing and data processing requirements of vehicles with ADAS levels L3 or L4, and infotainment levels BASIC, MID or HIGH to be addressed.

For a vehicle with an infotainment level PREMIUM, computing and data processing requirements increase compared with infotainment levels HIGH and BASIC, MID, notably due to screen management and the increase in the number of infotainment devices. However, computing and data processing requirements remain relatively generic as long as the vehicle has an ADAS level of L2+or L2. Calculation and data processing requirements are then addressed by a system 800 with two hubs 102 to provide a sufficient number of interfaces for the infotainment devices, each associated with a microchip 106 to perform the calculations and data processing associated with this infotainment level and the ADAS level L2 or L2+.

Finally, for a vehicle with an ADAS level L3 or L4 with an infotainment level PREMIUM, the use of four circuits 102 makes it possible to manage the large quantity of data to be processed and redistributed in the system, the use of two microchips 106 allows the generic computing and data processing requirements associated with the infotainment level PREMIUM to be met, and the use of two microchips 108 allows the specific computing and data processing requirements associated with the ADAS level L3 or L4 to be met. The system 900 allows therefore the requirements of a vehicle in this range to be met.

Various embodiments and variants have been described. Those skilled in the art will understand that certain features of these embodiments can be combined and other variants will readily occur to those skilled in the art. In particular, although the interest of circuit 102, and, more generally, of computing and data processing systems has been presented in relation to the automotive field, circuit 102 and computing and data processing systems obtained by modular construction from at least one circuit 102 can be used, with the same advantages, in other fields such as, for example, the field of avionics, the field of drones, the field of robotics etc. Furthermore, although we have described above the case where when two hubs 102 forming part of the same system or calculator are connected to each other via their ports P1 and a link 112, the two hubs then form part of the same cache-coherent memory area, by way of example it is also possible to connect two systems or computers together, via a link 112 between the port P1 of a hub of the first system and the port P1 of a hub of the second system. In the latter case, the two hubs are preferably part of two memory areas with different cache coherency, and, for example, input/output coherency is implemented between the two hubs, i.e. between the two systems. In other words, a port P1 configured to implement cache coherency is preferably also configured to enable the implementation of input/output coherency, although the reverse is not true. For example, connecting several systems together allows a redundant system to be implemented.

Finally, the practical implementation of the embodiments and variants described herein is within the capabilities of those skilled in the art based on the functional description provided hereinabove.

1. A communication hub circuit comprising:
at least two first physical ports each configured to exchange data with another communication hub circuit forming part of the same cache-coherent memory area as said hub circuit, when said first port is connected via a high-speed link to this other communication hub circuit;
at least one second physical port configured to exchange data with a computing microchip forming part of said same cache-coherent memory area when said at least one second physical port is connected via a high-speed link to this computing microchip;
at least one third physical port configured to exchange data with an accelerator microchip forming part of an input/output coherent memory area with said same cache coherent memory area, when said at least one third physical port is connected via a high-speed link to this accelerator microchip;
at least one first interface configured to exchange data with a memory circuit forming part of said same cache-coherent memory area when said at least one first interface is connected to this memory circuit;
at least one second interface configured to exchange data with a sensor;
at least one processing circuit configured to implement data processing;
at least one network-on-chip configured to transfer data between elements of the communication hub circuit, said elements comprising said at least two first ports, said at least one second port, said at least one third port, said at least one processing circuit and said at least one first interface.

2. The hub circuit according to claim 1, wherein:
said at least two first physical ports are each configured to implement a CXL.mem and CXL.cache or AXI stream protocol when exchanging data with the other communication hub circuit;
said at least one second physical port is configured to implement a CXL.cache and CXL.mem protocol when exchanging data with the computing microchip; and
said at least one third physical port is configured to implement a CXL.mem, CXL.io or PCIe protocol when exchanging data with the accelerator microchip.

3. The hub circuit according to claim 1, wherein the hub circuit is configured to merge several data flows it receives without implementing any processing on said several flows.

4. The hub circuit according to claim 1, wherein the hub circuit is configured to implement processing on separate data flows it receives and then to merge the results of these processing.

5. The hub circuit according to claim 1, wherein the hub circuit is configured to implement cache coherency in said same cache-coherent memory area.

6. The hub circuit according to claim 1, wherein the hub circuit is configured to implement input/output coherency between the same cache-coherent memory area and another memory area to which an accelerator microchip belongs.

7. The hub circuit according to claim 1, wherein said at least one first interface comprises an interface for a DDR-type memory and/or an interface for a FLASH-type memory.

8. The hub circuit according to claim 1, wherein the hub circuit further comprises a direct memory access circuit.

9. The hub circuit according to claim 1, wherein said at least one second interface comprises at least one CSI-type interface and/or at least one Ethernet-type interface.

10. The hub circuit according to claim 1, wherein the hub circuit further comprises at least one third interface configured to exchange data with a display.

11. A system comprising:
exactly one hub circuit according to claim 1; and
a memory connected to said at least one first interface, no computing microchip and accelerator microchip being connected to the hub circuit.

12. A system comprising:
exactly one hub circuit according to claim 1; and
a computing microchip connected to said at least one second port of the hub circuit by a high-speed link, no other computing microchip and no accelerator microchip being connected to the hub circuit.

13. A system comprising:
exactly one first hub circuit according to claim 1 and one second hub circuit according to claim 1, one of the first ports of the first hub circuit being connected to one of the first ports of the second hub circuit by a first high-speed link;
a first computing microchip connected to said at least one second port of the first hub circuit by a second high-speed link, no other computing microchip and no accelerator microchip being connected to the first hub circuit; and
a second computing microchip connected to said at least one second port of the second hub circuit by a third high-speed link, no other computing microchip and no accelerator microchip being connected to the second hub circuit.

14. A system comprising:
exactly one first hub circuit according to claim 1 and one second hub circuit according to claim 1, one of the first ports of the first hub circuit being connected to one of the first ports of the second hub circuit by a first high-speed link;
a first computing microchip connected to said at least one second port of the first hub circuit by a second high-speed link, no other computing microchip and no accelerator microchip being connected to the first hub circuit; and
a first accelerator microchip connected to said at least one third port of the second hub circuit by a third high-speed link, no other accelerator microchip and no computing microchip being connected to the second hub circuit.

15. A system comprising:
exactly one first hub circuit according to claim 1, a second hub circuit according to claim 1, a third hub circuit according to claim 1, a fourth hub circuit according to claim 1, one of the first ports of the first circuit being connected to one of the first ports of the second circuit by a first high-speed link, another of the first ports of the second circuit being connected to one of the first ports of the third circuit by a second high-speed link, another of the first ports of the third circuit being connected to one of the first ports of the fourth circuit by a third high-speed link, another of the first ports of the fourth circuit being connected to another of the first ports of the first circuit by a fourth high-speed link;
a first computing microchip connected to said at least one second port of the first hub circuit by a fifth high-speed link, no other computing microchip and no accelerator microchip being connected to the first hub circuit;
a second computing microchip connected to said at least one second port of the second hub circuit by a sixth high-speed link, no other computing microchip and no accelerator microchip being connected to the second hub circuit;
a first accelerator microchip connected to said at least one third port of the third hub circuit by a seventh high-speed link, no other accelerator microchip and no computing microchip being connected to the third hub circuit;
a second accelerator microchip connected to said at least one third port of the fourth hub circuit by an eighth high-speed link, no other accelerator microchip and no computing microchip being connected to the fourth hub circuit.

16. The system according to claim 14, wherein each accelerator microchip is configured to implement data processing for advanced pilot assistance systems of level L2+, L3, or L4.
